(19) United States
(12) Patent Application Publication
(10) Pub. No.: US 2006/0029516 A1
(43) Pub. Date: Feb. 9, 2006

(54) Sensor films and systems and methods of detection using sensor films

(75) Inventor: Radislav Alexandrovich Potyrailo, Niskayuna, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 10/913,909

(22) Filed: Aug. 9, 2004

(51) Int. Cl. G01N 31/22

(52) U.S. Cl. 422/56; 422/58

(57) ABSTRACT

A sensor film as well as a method and sensor array for detecting at least one analyte is described. The method of detecting at least one analyte includes providing at least one sensor, disposing at least one sensor film on the sensor, placing the sensor disposed with the sensor film in an environment that may contain at least one analyte, and relating at least one quantitative response to the concentration of the analyte.

### BACKGROUND

The invention relates to sensor films and methods of detection using sensor films. In particular, the invention relates to sensor films comprising a biopolymer protein material.

Chemical sensors generally have varying configurations. Typically, a chemical sensor includes a chemically sensitive film, often referred to as a “coating”, deposited on a sensor, for example onto a surface of a sensor. Interactions of the film with an analyte, which is a chemical species to be detected, induces a response in at least a property of the film, such as film refractive index, thickness, mass, viscoelastic property, absorbance, luminescence and many others. Further, the response may be related to the analyte concentration.

Existing sensors with sensor films have various disadvantages, such as, for example, difficulty in maintaining sensor response over a dynamic range of interest and with the required sensitivity over the whole dynamic range. Certain sensor films may not provide controlled, accurate, reliable, and repeatable detection operations. For example, it is known that some sorbing polymer films, which are films that accept chemical species into its interior, may exhibit decreased sensing characteristics, including but not limited to, decreased stability and sensitivity during detection operations, when in contact with certain materials and environments. Further, some sorbing polymer films can decrease sensing operational characteristics upon interactions aqueous solutions of organic solvents. Furthermore, various sorbing polymer films can decrease sensing operational characteristics upon interactions with certain types of solutions, such as alkaline solutions. Moreover, some polymer films are chemically unstable and may undergo adverse chemical changes after contact with an analyte or target material. Additionally, some polymer films are mechanically unstable and may undergo adverse mechanical characteristic changes after contact with an analyte or target material.

Therefore, a need exists for sensor films that provide one or more of the following advantages: retain desirable sensing characteristics if in contact with an analyte; provide controlled, accurate, reliable, and repeatable detection when in contact with an analyte; dissolvable in a variety of solvents; usable as immobilization supports for a variety of reagents; usable to detect an analyte in water and air; and, easily modifiable to fit a specific sensor application.

### SUMMARY

The purpose and advantages of embodiments of the invention will be set forth and apparent from the description that follows, as well as will be learned by practice of the embodiments of the invention. Additional advantages will be realized and attained by the methods and systems particularly pointed out in the written description and claims hereof, as well as from the appended drawings.

An embodiment of the invention provides a sensor film comprising at least one biopolymer protein material. The sensor film has a thickness greater than one biopolymer protein molecule and provides at least one quantitative response in relation to the concentration of at least one analyte.

Another embodiment provides a method of making a sensor film. The method comprises: i) providing at least one biopolymer protein material in a solvent; and ii) depositing the at least one biopolymer protein material onto a substrate. The method may further comprise removing the solvent. The sensor film comprises at least one biopolymer protein material. The sensor film has a thickness greater than one biopolymer protein molecule and provides at least one quantitative response in relation to the concentration of at least one analyte. It is to be understood that both the foregoing general description and the following detailed description are exemplary and are intended to provide further explanation of the invention claimed.

Another embodiment provides a method of detecting at least one analyte. The method includes i) providing at least one sensor; ii) disposing at least one sensor film on the at least one sensor; iii) placing the at least one sensor disposed with the at least one sensor film in an environment wherein the environment may contain the at least one analyte; and iv) relating the at least one quantitative response to the concentration of at least one analyte. The sensor film comprises at least one biopolymer protein material. The sensor film has a thickness greater than one biopolymer protein molecule and provides at least one quantitative response in relation to the concentration of at least one analyte.

Another embodiment provides a sensor array configured for determining the presence of at least one analyte. The sensor array includes i) at least one sensor; and ii) at least one sensor film disposed on the at least one sensor. The sensor film comprises at least one biopolymer protein material. The sensor film has a thickness greater than one biopolymer protein molecule and provides at least one quantitative response in relation to the concentration of at least one analyte.

The accompanying figures, which are incorporated in and constitute part of this specification, are included to illustrate and provide a further understanding of the method and system of the invention. Together with the description, the drawings serve to explain the principles of the invention.

### BRIEF DESCRIPTION OF THE DRAWINGS

FIG. 1 schematically illustrates a sensor array constructed in accordance with an embodiment of the invention.

FIG. 2 illustrates process steps for making a sensor film with a biopolymer protein material in accordance with another embodiment of the invention.

FIG. 3 illustrates process steps for detecting an analyte with the biopolymer protein sensor film of FIG. 2.

FIG. 4 illustrates a spectral change of an immobilized biopolymer protein material with bromo cresol green (BCG) reagent upon exposure to different pH.

FIG. 5 illustrates a dynamic response of biopolymer protein-BCG film to pH 10 solutions.

FIG. 6 illustrates response curves of a biopolymer protein sensor material toward different pH.

FIG. 7 illustrates a comparison of responses of biopolymer protein BCG sensor material films toward different pH.

FIG. 8 illustrates a response of the biopolymer protein BCG film to water samples with different pH and nature of buffers.

FIG. 9 illustrates a change in fluorescence spectra of nile red immobilized in the biopolymer protein film upon exposure of the film to toluene.

FIG. 10 illustrates a dynamic response of the sensor response upon exposure to toluene.

FIG. 11 illustrates a response of a biopolymer protein film to exposure to an analyte vapor pronounced as a shift of the interference fringe pattern.

FIG. 12 illustrates a signal produced by a biopolymer protein film recorded at a single wavelength upon exposure to an analyte vapor.

### DETAILED DESCRIPTION OF EXEMPLARY EMBODIMENTS

Reference will now be made in detail to exemplary embodiments of the invention which are illustrated in the accompanying figures and examples.

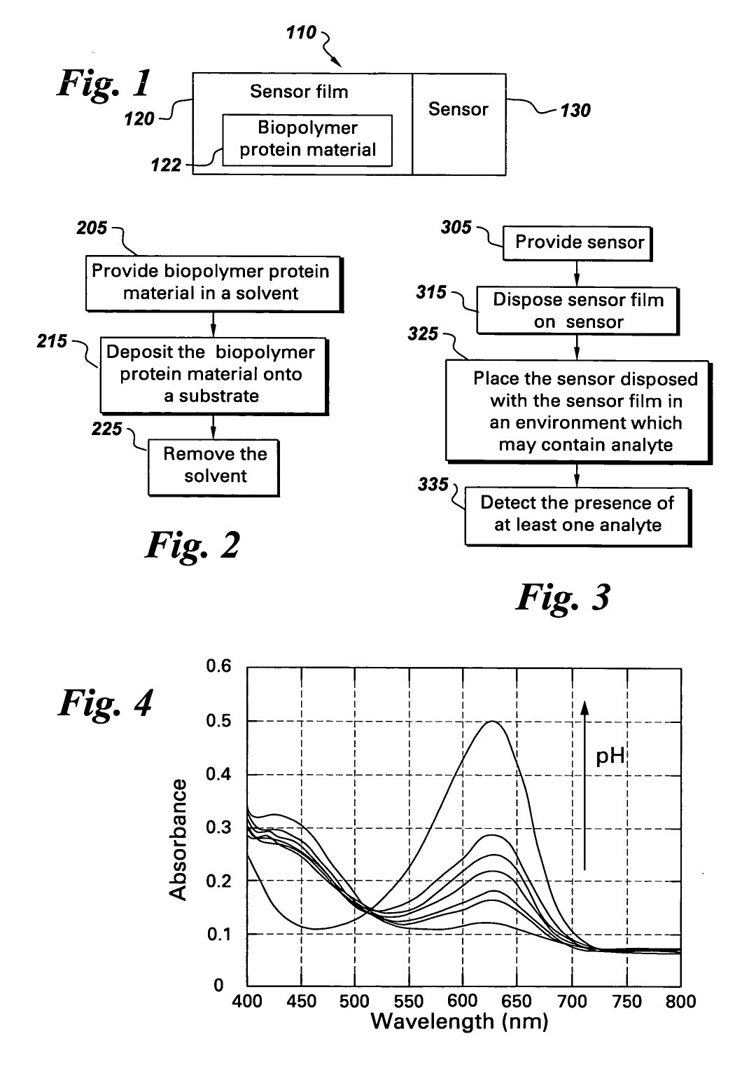

With reference to FIG. 1, a sensor array 110 is schematically depicted. The sensor array 110, which is configured for determining the presence of at least one analyte, includes at least one sensor 130 and at least one sensor film 120. The sensor film 120, which may be disposed on the sensor 130, includes at least one biopolymer protein material 122. The sensor film 120 has a thickness greater than one biopolymer protein molecule and provides at least one quantitative response in relation to the concentration of at least one analyte. For example, the sensor film 120 may have a thickness in the range from about 10 nanometers to about 500 micrometers. In a particular embodiment, the thickness may be in the range from about 20 nanometers to about 250 micrometers. In another particular embodiment, the thickness may be in the range from about 50 nanometers to about 100 micrometers.

The sensor film 120 may be use to detect analytes in water and air samples. The analyte may be a chemical species. The quantitative response of the sensor film 120 to the analyte may encompass a chemical response, a physical response, a dielectric response, a thickness response, a viscoelastic response, a mass response, an optical response, and combinations thereof.

In one embodiment, the biopolymer protein material 122 includes at least one biopolymer from a class of alcohol soluble prolamines. Examples of biopolymers of a class of alcohol soluble prolamines are gliadin, hordeine, zein, other related alcohol soluble prolamines, and combinations thereof. In one embodiment, the top zein biopolymer protein film may also serve as a selective membrane. A selective membrane preferably transports certain analytes to make them available for interactions with the sensor film 120 underneath.

In one embodiment, the sensor film 120 exhibits adhesive tendencies toward the sensor 130 so that when the sensor film is exposed to water, the sensor film 120 stays disposed to the sensor 130. The sensor film 120 also exhibits transparency and film uniformity. The film uniformity is indicated by a lack of significant variation in film thickness over the area of interest. Examples of film thickness variations are less than 10% of total thickness. A particular example is a variation of less than 5%, and more particularly less than 3%. These transparency and film uniformity characteristics provide the film with acceptable optical quality, i.e., no noticeable image distortion when an object is viewed through such a film.

In one embodiment, the sensor film 120 is a single layer film where all the needed components in the film are distributed in a single layer. A single layer simplifies the design and the fabrication steps by limiting the number of coating steps. The sensor film 120 can be optionally cross-linked. Cross-linking provides an additional robustness of the film towards mechanical environmental effects such as rubbing, etc. and an additional solvent-resistance. Further, cross-linking enables diverse responses of different sensor films upon different levels of cross-linking. Such diversity originates from the chemical changes due to different cross-linking and physical changes. Chemical changes mainly affect the magnitude of the response of the sensor film 120 to an analyte and to some extent affects the kinetics of the response. Physical changes affect the kinetics of the response and to some extent the magnitude of the response.

Although the sensor film 120 may be optionally cross-linked, zein polymers that are not cross-linked also provide a desired performance, as described in the examples below.

The sensor film 120 may optionally include at least one additive. Examples of additives are chemical reagents, plasticizers, polarity modifiers, acidity modifiers, and combinations thereof. Examples of plasticizers include high molecular weight fatty acids, water, propylene glycol, poly(ethylene glycol), higher boiling point glycerol derivatives, tri(ethylene glycol), high-molecular weight glycol esters, esters of tartaric acid, polyol, and esters of hydroxy acids. Acidity modifiers are used to adjust pH of zein. Examples of acidity modifiers include volatile acids and bases, such as ammonia, acetic acid, and others. Polarity modifiers include enzymatic hydrolysis, acidic deamidation with HCl (pH<1), and alkaline deamidation with NaOH.

The biopolymer of the class of alcohol soluble prolamines can also be chemically modified. For example, chemical modification can be performed with 1-[3-dimethylaminopropyl]-3-ethyl-carbodiimide hydrochloride, formaldehyde, silicate, N-hydroxysuccinimide, and other reagents. The class of alcohol soluble prolamines can also be cross-linked, for example, with UV radiation or formaldehyde.

The sensor film 120 may further include another polymer to provide a polymer blend with a biopolymer protein material. The biopolymer protein material in combination with another polymer may change the response pattern of the sensor film 120 to an analyte and any interfering species. This change in response pattern helps in providing more accurate measurements. This change in response may be pronounced as a change in the magnitude of signal overall generated from such sensor film 120 and/or the temporal response of the signal upon exposure of blended sensor films to an analyte and any interfering species. In one embodiment, examples of polymers include polycaprolactone, rosin, manilla, shellac, and poly(N,N)-dimethylacrylamide. The sensor film 120 may optionally include at least one reagent that changes optical property upon exposure to chemical species. In one embodiment, the reagent may be bromo cresol green (BCG) reagent, nile red, methylene blue, crystal violet reagents, and many other reagents soluble in the same solvents as prolamines.

The sensor film 120 may optionally be configured to protect a surface. The sensor film 120 protects the surface of the sensor 130 by providing an enhanced durability from mechanical abrasion and chemical attack.

With reference to FIG. 2, next will be described a method of making the sensor film 120. The method includes, at step 205, providing at least one biopolymer protein material 122 in a solvent. The biopolymer protein material 122 may be, for example, a zein biopolymer film. Examples of solvents for making zein biopolymer films include, but are not limited to, m-aminophenol, diethanolamine, N,N-dimethylformamide, diethylene glycol, hydroxyethylethylenediamine, 2-hydroxymethyl-1,3-dioxolane, lactic acid, methyl alcohol, methyl lactate, monoethanolamine, monoisopropanolamine, morpholine, morpholine ethanol, phenol, phenyl cellosolve; phenyldiethanolamine, phenyl ethanolamine, propylene glycol, resorcinol monoacetate, triethanolamine; triethylenetetramine, tetrahydrofurfuryl alcohol, triethylene glycol, anolamine, timethylaminomethane, and combinations thereof. Binary and tertiary solvents are also possible to use as described in the art for conventional applications of zein polymer. These solvents are applicable for the fabrication of sensor films provided that optional components in the sensor film cocktail formulation are also soluble in the respective selected solvent.

At step 215, depositing the biopolymer protein material onto a substrate is performed. The method may also include, at step 225, removing the solvent. Examples of ways of removing the solvent include, but are not limited to, solvent evaporation at room temperature or at elevated temperature, such as in a range from 25° C. to 60° C. Solvent may also be removed by reducing ambient pressure.

The biopolymer protein sensor film 120 deposited on the sensor 130 permits the sensor 130 to detect various analytes. With reference to FIG. 3, next will be described a method of detecting at least one analyte. The method includes, at step 305, providing at least one sensor 130. It should be appreciated that multiple sensors 130 may be provided in step 305. At step 315, disposing at least one sensor film 120 on the sensor 130 is performed. It should be appreciated that a plurality of sensor films 120 may be disposed on the sensor 130. The method also includes, at step 325, placing the sensor 130 with the sensor film 120 in an environment that may contain at least one analyte.

At step 335, the presence of at least one analyte is detected. The analyte is detected by relating the quantitative response of the sensor film 120 to the concentration of the at least one analyte.

It should be appreciated that more than one analyte may be detected in step 335 since any given environment may contain more than one analyte and the sensor film 120 may be enabled to detect more than one type of analyte. In addition, a plurality of sensor films 120 can comprise a sensor array 110, wherein each sensor film 120 contains at least one different additive, polarity modifier, acidity modifier, or reagent. A plurality of sensors 130 can operate as an array 110 where the signals from individual sensors 130 are mathematically processed to provide a single multivariate response using know multivariate signal processing tools. Non-limiting examples of such multivariate signal processing tools are pattern recognition, multivariate calibration, principal components analysis, partial least squares, locally weighted regression, neural networks, and any others known in the art.

The method may also include monitoring the at least one analyte. Monitoring the analyte can give an indication of the concentration of the analyte within a given environment over a period of time. The period of time may be vary, such as ranging from 1 microsecond to 10 years, from 100 microseconds to 5 years, or from 1 milliseconds to 3 years.

The biopolymer protein material 122 can be dissolved in a variety of solvents and can be cast into chemically sensitive films. The biopolymer proteins can be used as sensor materials for direct measurement of an analyte. Direct measurement is conducted due to the interactions of analytes in liquid and air with the surface or bulk of the film. Further, these biopolymer proteins can be used as immobilization supports for a variety of reagents and can be used to detect chemical analytes in water and air. Because of the nature of biopolymer protein films, the biopolymer protein films can be easily modified to fit a specific sensor application. Modification is achieved using any known methods that include, but are not limited to, environmental treatment such as temperature, electromagnetic radiation, UV light, and chemical treatment such as addition of additives, plasticizers, cross linking, and others known in the art.

Interactions of the biopolymer protein sensor films 120 with an analyte and interfering analytes may be pronounced in the changes of the film dielectric, electric, electrochemical, optical, chemical, mechanical, physical, and any other detectable properties. For example, a change in the optical path length is observed upon interactions with vapors, which is indicative of a sorption of the vapor into the bulk of the protein film rather than adsorption onto the surface of the film.

In one embodiment, a biopolymer protein is dissolved in a solvent or solvent combination and a sensor film 120 is formed from the solution using known deposition methods. Non-limiting examples of these deposition methods include ink-jet printing, spray coating, screen-printing, array microspotting, dip coating, solvent casting, draw coating and any other known in the art. Sensor films can be arranged in arrays. The film interacts with a variety of analytes including gases, ions, small organic molecules, large organic molecules and biomolecules. These film interactions are pronounced as a change in film properties that include film dielectric, electric, electrochemical, optical, chemical, mechanical, physical, and any other detectable properties.

In another embodiment, a solution of a biopolymer protein and a chemically sensitive reagent is made and a sensor film 120 is formed from the solution using known deposition methods. Solution of a biopolymer protein may contain an additive such as a plasticizer, polarity modifier, acidity modifier, or reagent-leaching reducing agent. The film interacts with a variety of analytes including gases, ions, small organic molecules, large organic molecules and biomolecules. These film interactions are pronounced as a change in film properties that include film dielectric, electric, electrochemical, optical, chemical, mechanical, physical, and any other detectable properties.

In another embodiment, a solution of a biopolymer protein and an additive such as a plasticizer, polarity modifier, acidity modifier or any other additive is made and a sensor film 120 is formed from the solution using known deposition methods. The film interacts with a variety of analytes including gases, ions, small organic molecules, large organic molecules and biomolecules. These film interactions are pronounced as a change in film properties that include film dielectric, electric, electrochemical, optical, chemical, mechanical, physical, and any other detectable properties.

In another embodiment, a biopolymer protein is blended with another polymer and optionally an additive such as a plasticizer, polarity modifier, acidity modifier, or any other additive is used and a sensor film 120 is formed from such a biopolymer-polymer blend. Examples of polymers include, but are not limited to, polycaprolactone, rosin, manilla, shellac, and poly(N,N)-dimethylacrylamide. The film interacts with a variety of analytes including gases, ions, small organic molecules, large organic molecules and biomolecules. These film interactions are pronounced as a change in film properties that include film dielectric, electric, electrochemical, optical, chemical, mechanical, physical, and any other detectable properties.

In another embodiment, a blend of the biopolymer protein with another polymer and optionally an additive such as a chemical reagent, plasticizer, polarity modifier, acidity modifier, or any other additive instead may be used to form a sensor film 120. The film 120 interacts with a variety of analytes including gases, ions, small organic molecules, large organic molecules and biomolecules. These film interactions are pronounced as a change in film properties that include film dielectric, electric, electrochemical, optical, chemical, mechanical, physical, and any other detectable properties. The sensor film 120 is used for detection of species in liquid and air for a variety of applications, including but not limited to, industrial water and air analysis, wastewater analysis, environmental water and air analysis, breath air analysis, body fluids analysis, home water and home air analysis, and any other suitable application where chemical and biological sensors may be used.

In another embodiment, a blend of a biopolymer protein with another polymer and optionally an additive such as a chemical reagent, plasticizer, polarity modifier, acidity modifier, or any other additive may be used to form a sensor film 120. The sensor film 120 serves as a biocompatible medium for in-vivo sensing applications. Optionally, the sensor film 120 is a multiple layer film where one of the layers has a sensing reagent.

In another embodiment, a blend of a biopolymer protein with another polymer and optionally an additive such as a chemical reagent, plasticizer, polarity modifier, acidity modifier, or any other additive may be used along with an overcoat film to form the sensor film 120. The sensing film can be any sensing film known in the art or the one disclosed herein and is used for determinations of species in water or air.

Biopolymers of a zein group may have at least one of the following characteristics. Biopolymers of a zein group may exhibit ease of incorporation of reagent into the support film. Biopolymers of a zein group may preserve sensitivity of the reagent toward the chemical analyte. Biopolymers of a zein group may exhibit film-forming property such as thin, transparent, uniform film and other film properties such as water wettability, which is the contact angle between a droplet of water in thermal equilibrium on a horizontal surface of sensor film. Biopolymers of a zein group may minimize mechanical or abrasion resistance of the films such as minimal distortion after water removal.

### EXAMPLES

The examples of the biopolymer protein films demonstrate the broad applicability of the biopolymer protein sensor films 120 for determining a variety of analytes in water and air with and without reagents. The following examples are included for the purpose of exemplification and are not to be construed as limiting the scope of the present invention.

### Example 1

Biopolymer zein protein (about 0.5 cm³ by volume) was dissolved in 1-methoxy-2-propanol (about 3 mL) at about 50° C. About 60 μL of dissolved reagent was added to 1 mL of zein solution. Reagent was bromo cresol green (BCG) dissolved in 1-methoxy-2-propanol. To make a sensor film, reagent-containing solution was flow coated onto a polycarbonate sheet and dried overnight at room temperature in air.

Measurements of optical properties of the sensor film were performed using an OCEAN OPTICS™ spectrometer with a fiber-optic probe. The polycarbonate sheet had a TEFLON® backing tape that was intact during the measurements and it served as a scatter layer. Measurement angle was selected to be about 10 degrees from the normal to the surface of the sensor film.

For construction of response curves, samples of synthetic cooling water were used with different pH in the range from 4 to 10. Exposure conditions of the sensor films were as follows: sample volume was 50 μL; exposure time was 180 seconds; sample removal was done as a pipette-off followed by water removal with an absorping material such as a sponge, for example, a KIMWIPE®. A very light reproducible leaching was observed at high pH.

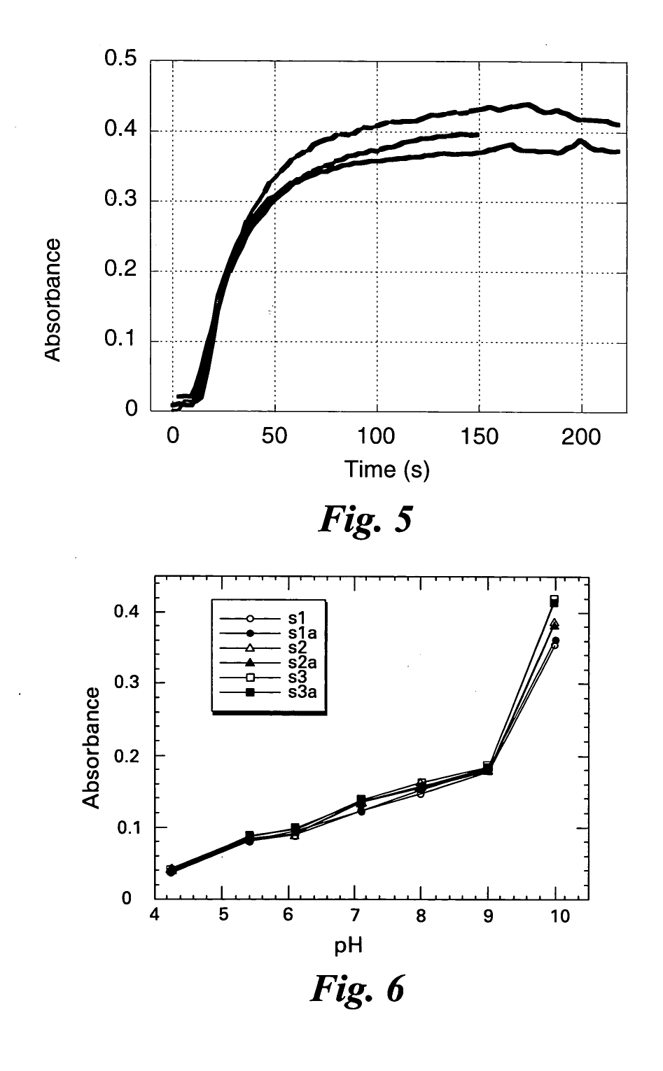

Results of the spectral measurements of sensor film regions after exposure to different pH levels are presented in FIG. 4. These measurements were performed after exposure to water samples for 180 seconds. Results of three replicate measurements of the dynamic response of the sensor film upon exposure to pH 10 are presented in FIG. 5.

Response curves of sensor materials toward different pH are presented in FIG. 6 where each spot was measured with two replicates. This data shows reproducibility of the response. The data in FIG. 6 is the result of a single measurement per spot averaged across three replicate spots. A summary of measurement results is provided in Table 1.

TABLE 1

| | Absorbance | Standard Deviation, | % Relative |
|---|---|---|---|
| pH | (mean) | n = 3 | Standard Deviation |
| 4.24 | 0.0398 | 0.00224 | 5.62 |
| 5.4 | 0.0837 | 0.00335 | 3.95 |
| 6.1 | 0.0949 | 0.0032 | 3.37 |
| 7.1 | 0.135 | 0.00845 | 6.47 |
| 8 | 0.154 | 0.00333 | 2.16 |
| 9 | 0.181 | 0.00302 | 1.67 |
| 10 | 0.384 | 0.028 | 7.35 |

### Example 2

Biopolymer zein protein (about 1.5 cm³ by volume) was dissolved in 1-methoxy-2-propanol (about 3 mL) at about 50° C. About 180 μL of dissolved reagent was added to 1 mL of zein solution. The reagent was bromo cresol green (BCG) dissolved in 1-methoxy-2-propanol. To make a sensor film, reagent-containing solution was flow coated onto a polycarbonate sheet and dried overnight at room temperature in air. Measurements of optical properties of the sensor film were performed using an OCEAN OPTICS™ spectrometer with a fiber-optic probe. The polycarbonate sheet had a TEFLON® backing tape that was intact during the measurements and it served as a scatter layer. Measurement angle was selected to be about 10 degrees from the normal to the surface of the sensor film.

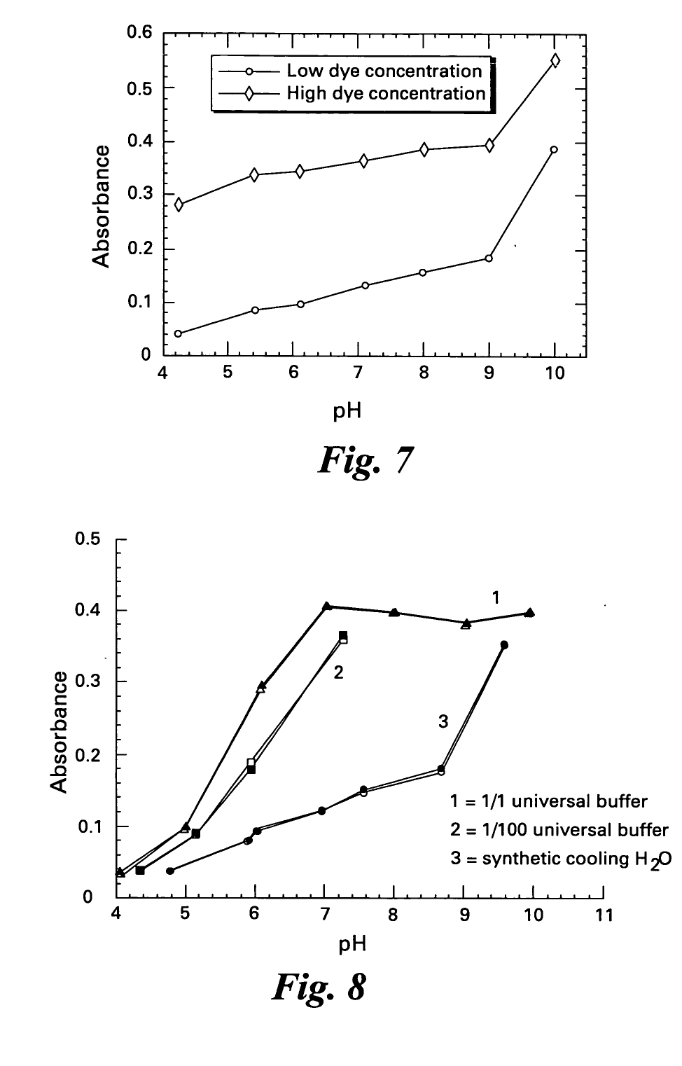

For construction of response curves, samples of synthetic cooling water were used with different pH in the range from 4 to 10. Exposure conditions of the sensor films were as follows: sample volume was 50 μL; exposure time was 180 s; sample removal was done as a pipette-off followed by water removal with an absorping material such as a sponge or KIMWIPE®. Response curves of sensor materials toward different pH are presented in FIG. 7 where each spot was measured with once. This data shows a reproducibility of the response. FIG. 7 also compares the response of the sensor film 120 shown in FIG. 4.

### Example 3

Biopolymer zein protein sensor film was fabricated as described in Example 1. Measurements of optical properties of the sensor film were performed using the setup described in Example 1. For construction of response curves, samples of universal buffer were used where buffer strength was 1/1 and diluted by 100 fold (1/100). Results of the sensor film response were compared with those produced from exposure to synthetic cooling water. Exposure conditions of the sensor films were same as in Example 1. FIG. 8 shows the response of the biopolymer-BCG sensor film to water samples with different pH and nature of buffers.

### Example 4

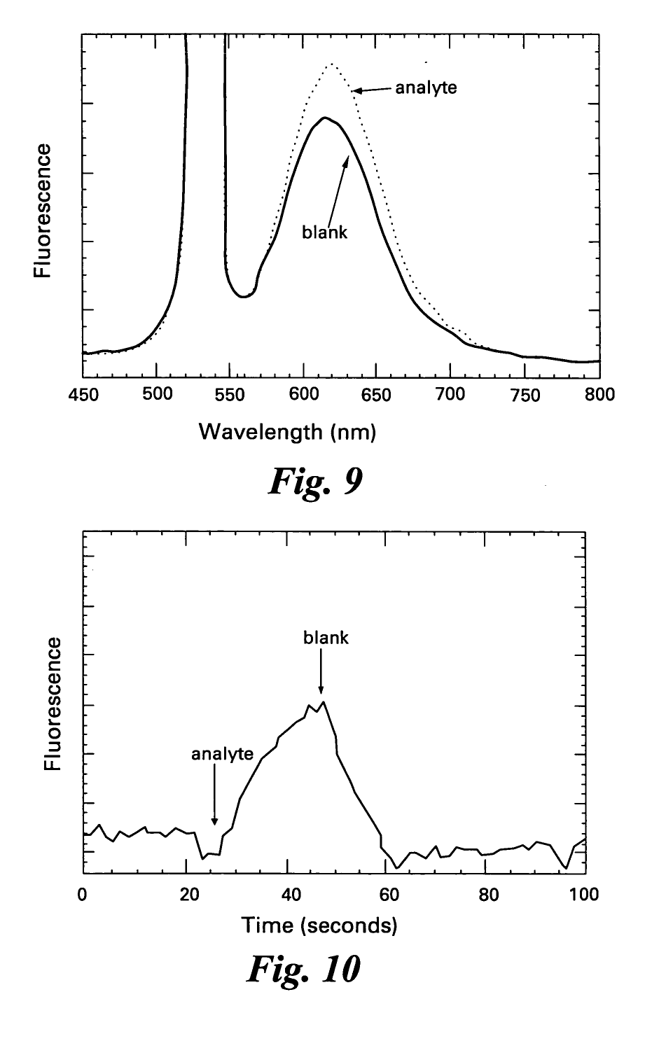

Biopolymer zein protein (about 1.5 cm³ by volume) was dissolved in 1-methoxy-2-propanol (about 3 mL) at about 50° C. About 50 μL of dissolved reagent was added to 1 mL of zein solution. Reagent was a solvatochromic dye Nile red dissolved in 1-methoxy-2-propanol. To make a sensor film, reagent-containing solution was flow coated onto a polycarbonate sheet and dried overnight at room temperature in air. Measurements of optical properties of the sensor film were performed using an OCEAN OPTICS™ spectrometer with a fiber-optic probe. Fluorescence of the immobilized reagent was excited with a 532 nm laser. Fluorescence of the immobilized reagent was changed as a function of polarity of its local microenvironment. For example, the change in fluorescence was pronounced upon exposure of the sensor film to toluene. FIG. 9 illustrates the changes in fluorescence spectra upon exposure of the sensor film to toluene. Dynamic response of the sensor was monitored at 615 nm and is depicted in FIG. 10.

### Example 5

Zein polymer (about 1.5 cm³ by volume) was dissolved in 1-methoxy-2-propanol (about 3 mL) at about 50° C. To make a sensor film, reagent-containing solution was flow coated onto a polycarbonate sheet and dried overnight at room temperature in air. Measurements of optical properties of the sensor film were performed using an OCEAN OPTICS™ spectrometer with a fiber-optic probe. The polycarbonate sheet had a TEFLON® backing tape that was intact during the measurements and it served as a scatter layer. Measurement angle was selected to be about zero degrees from the normal to the surface of the sensor film.

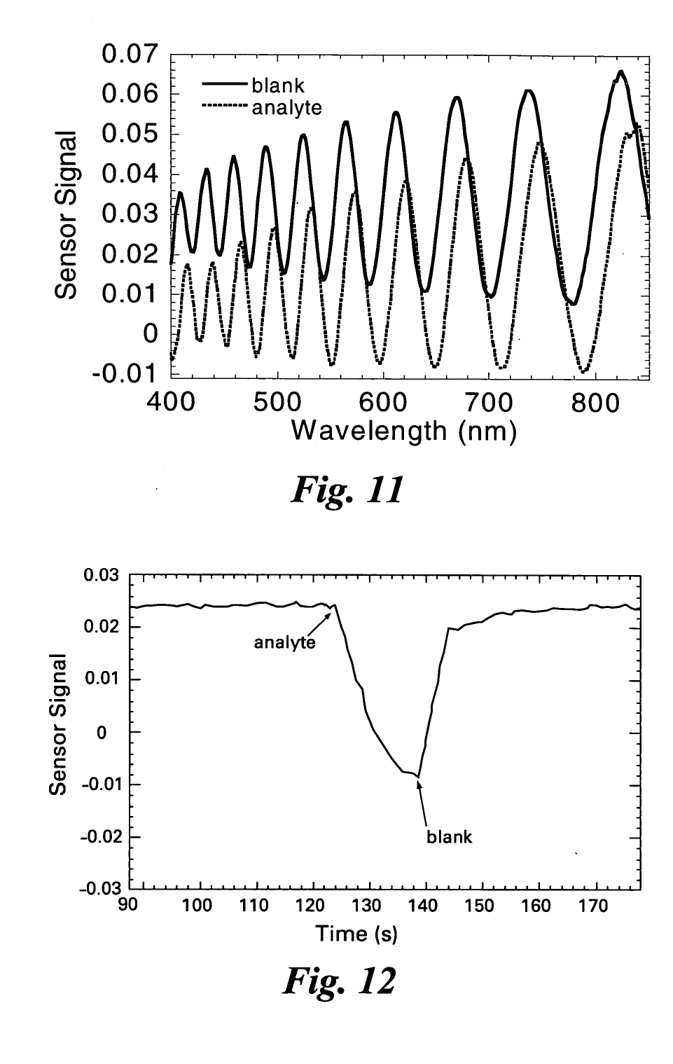

Upon normalizing the light reflected from the sensor film to the light reflected from the bare substrate, a set of interference fringes is observed when a white light source is used. The periodicity of these interference fringes is related to the refractive index and thickness of the sensor film. Upon exposure of the sensor film to an analyte vapor (toluene), a shift of the fringe pattern is observed as shown in FIG. 11. This shift is due to the change in the optical pathlength of reflected light upon interactions with the vapor, which is indicative of a sorption of the vapor into the bulk of the protein sensor film rather than adsorption onto the surface of the sensor film. Monitoring of the signal change at a single wavelength (650 nm) provides a quantitative sensor film response to analyte vapor as shown in FIG. 12.

While the invention has been described in detail in connection with only a limited number of aspects, it should be readily understood that the invention is not limited to such disclosed aspects. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A sensor film comprising;
at least one biopolymer protein material;
wherein the sensor film has a thickness greater than one biopolymer protein molecule; and
wherein the sensor film provides at least one quantitative response in relation to the concentration of at least one analyte.

2. The sensor film of claim 1, further comprising at least one additive selected from a group consisting of a chemical reagent, a plasticizer, a polarity modifier, an acidity modifier, and combinations thereof.

3. The sensor film of claim 1, further comprising at least one reagent.

4. The sensor film of claim 1, wherein the at least one biopolymer protein material comprises a class of alcohol soluble prolamines.

5. The sensor film of claim 4, wherein the class of alcohol soluble prolamines comprises a zein group.

6. The sensor film of claim 1, wherein the at least one quantitative response is selected from a group consisting of a dielectric response, a thickness response, a viscoelastic response, a mass response, an optical response, and combinations thereof.

7. The sensor film of claim 1, wherein the at least one quantitative response is selected from a group consisting of a chemical response, a physical response, and combinations thereof.

8. The sensor film of claim 1, wherein the sensor film is configured to protect a surface of a sensor.

9. A sensor film comprising;
at least one biopolymer protein material;
at least one additive selected from a group consisting of a chemical reagent, a plasticizer, a polarity modifier, an acidity modifier, and combinations thereof; and
at least one reagent;
wherein the sensor film has a thickness greater than one biopolymer protein molecule; and
wherein the sensor film provides at least one quantitative response in relation to the concentration of at least one analyte.

10. The sensor film of claim 9, wherein the at least one biopolymer protein material comprises a class of alcohol soluble prolamines.

11. The sensor film of claim 10, wherein the class of alcohol soluble prolamines comprises a zein group.

12. The sensor film of claim 9, wherein the at least one quantitative response is selected from a group consisting of a dielectric response, a thickness response, a viscoelastic response, a mass response, an optical response, and combinations thereof.

13. The sensor film of claim 9, wherein the at least one quantitative response is selected from a group consisting of a chemical response, a physical response, and combinations thereof.

14. The sensor film of claim 9, wherein the sensor film is configured to protect a surface of a sensor.

15. A method of detecting at least one analyte, the method comprising:
i) providing at least one sensor;
ii) disposing at least one sensor film on the at least one sensor, wherein the at least one sensor film comprises:
at least one biopolymer protein material, wherein a thickness of the at least one sensor film is greater than one biopolymer protein molecule and wherein the at least one sensor film provides at least one quantitative response in relation to the concentration of at least one analyte;
iii) placing the at least one sensor disposed with the at least one sensor film in an environment containing the at least one analyte; and
iv) relating the at least one quantitative response to the concentration of the at least one analyte.

16. The method of claim 15, wherein the at least one sensor film further comprises at least one additive selected from a group consisting of a chemical reagent, a plasticizer, a polarity modifier, an acidity modifier, and combinations thereof.

17. The method of claim 15, wherein the at least one sensor film further comprises at least one reagent.

18. The method of claim 15, wherein the at least one biopolymer protein material comprises a class of alcohol soluble prolamines.

19. The method of claim 18, wherein the class of alcohol soluble prolamines comprises a zein group.

20. The method of claim 15, wherein the at least one quantitative response is selected from a group consisting of a dielectric response, a thickness response a viscoelastic response, a mass response, an optical response, and combinations thereof.

21. The method of claim 15, wherein the at least one quantitative response is selected from a group consisting of a chemical response, a physical response, and combinations thereof.

22. The method of claim 15, wherein the disposing of the at least one sensor film on the at least one sensor comprises disposing a plurality of the sensor films on the at least one sensor.

23. The method of claim 15, wherein the at least one sensor film further protects a surface of the at least one sensor.

24. The method of claim 15, wherein the at least one sensor comprises a plurality of sensors.

25. The method of claim 15, wherein the at least one analyte comprises a plurality of analytes.

26. The method of claim 15, further comprising monitoring the at least one analyte.

27. The method of claim 15 wherein the disposing is selected from a group consisting of ink-jet printing, spray coating, screen-printing, array microspotting, dip coating, solvent casting, draw coating and combinations thereof.

28. A method of detecting at least one analyte, the method comprising:
i) providing at least one sensor;
ii) disposing at least one sensor film on the at least one sensor, wherein the at least one sensor film provides at least one quantitative response in relation to the concentration of at least one analyte and wherein the at least one sensor film comprises:
at least one biopolymer protein material comprising a class of alcohol soluble prolamines, wherein a thickness of the at least one sensor film is greater than one molecule of the at least one biopolymer protein material; and
at least one reagent;
iii) placing the at least one sensor disposed with the at least one sensor film in an environment containing the at least one analyte; and
iv) relating the at least one quantitative response to the concentration of the at least one analyte.

29. The method of claim 28, wherein the at least one sensor film further comprises at least one additive selected from a group consisting of a chemical reagent, a plasticizer, a polarity modifier, an acidity modifier, and combinations thereof.

30. The method of claim 28, wherein the at least one quantitative response is selected from a group consisting of a dielectric response, a thickness response a viscoelastic response, a mass response, an optical response, and combinations thereof.

31. The method of claim 28, wherein the at least one quantitative response is selected from a group consisting of a chemical response, a physical response, and combinations thereof.

32. The method of claim 28, wherein the disposing of the at least one sensor film on the at least one sensor comprises disposing a plurality of the sensor films on the at least one sensor.

33. The method of claim 28, wherein the at least one sensor film further protects a surface of the at least one sensor.

34. The method of claim 28, further comprising monitoring the at least one analyte.

35. The method of claim 28, wherein the disposing is selected from a group consisting of ink-jet printing, spray coating, screen-printing, array microspotting, dip coating, solvent casting, draw coating, and combinations thereof.

36. A sensor array configured for determining the presence of at least one analyte, the sensor array comprising:
at least one sensor; and
at least one sensor film disposed on the at least one sensor, wherein the at least one sensor film comprises:
at least one biopolymer protein material, wherein a thickness of the at least one sensor film is greater than one biopolymer protein molecule, and wherein the at least one sensor film provides at least one quantitative response in relation to the concentration of at least one analyte.

37. The sensor array of claim 36, wherein the at least one sensor film further comprises at least one additive selected from a group consisting of a chemical reagent, a plasticizer, a polarity modifier, an acidity modifier, and combinations thereof.

38. The sensor array of claim 36, wherein the at least one sensor film further comprises at least one reagent.

39. The sensor array of claim 36, wherein the at least one biopolymer protein material comprises a class of alcohol soluble prolamines.

40. The sensor array of claim 40, wherein the class of alcohol soluble prolamines comprises a zein group.

41. The sensor array of claim 36, wherein the at least one quantitative response is selected from a group consisting of a dielectric response, a thickness response, a viscoelastic response, a mass response, an optical response, and combinations thereof.

42. The sensor array of claim 36, wherein the at least one quantitative response is selected from a group consisting of a chemical response, a physical response, and combinations thereof.

43. The sensor array of claim 36, wherein the disposing the at least one sensor film on the at least one sensor comprises disposing a plurality of the sensor films on the at least one sensor.

44. The sensor array of claim 36, wherein the at least one sensor comprises a plurality of sensors.

45. The sensor array of claim 36, wherein the at least one analyte comprises a plurality of analytes.

46. The sensor array of claim 36, wherein the at least one sensor film further protects a surface of the at least one sensor.

47. A method of making a sensor film comprising at least one biopolymer protein material, wherein a thickness of the sensor film is greater than one biopolymer protein molecule, and wherein the sensor film provides at least one quantitative response in relation to the concentration of at least one analyte, the method comprising:
i) providing at least one biopolymer protein material in a solvent;
ii) depositing the at least one biopolymer protein material onto a substrate; and
iii) removing the solvent.

48. The method of claim 47, wherein the disposing is selected from a group consisting of ink-jet printing, spray coating, screen-printing, array microspotting, dip coating, solvent casting, draw coating, and combinations thereof.

49. The method of claim 47, wherein the sensor film further comprises at least one additive selected from a group consisting of a chemical reagent, a plasticizer, a polarity modifier, an acidity modifier, and combinations thereof.

50. The method of claim 47, wherein the sensor film further comprises at least one reagent.

51. The method of claim 47, wherein the at least one biopolymer protein material comprises a class of alcohol soluble prolamines.

52. The method of claim 51, wherein the class of alcohol soluble prolamines comprises a zein group.

53. The method of claim 47, wherein the at least one quantitative response is selected from a group consisting of a dielectric response, a thickness response, a viscoelastic response, a mass response, and combinations thereof.

54. The method of claim 47, wherein the at least one quantitative response is selected from a group consisting of a chemical response, a physical response, and combinations thereof.

55. The method of claim 47, wherein the sensor film is configured to protect a surface of the at least one sensor.

56. The method of claim 47, wherein the providing at least one biopolymer protein material in a solvent comprises dissolving the at least one biopolymer protein material in the solvent.

57. A method of making a sensor film comprising at least one biopolymer protein material, wherein a thickness of the sensor film is greater than one biopolymer protein molecule, and wherein the sensor film provides at least one quantitative response in relation to the concentration of at least one analyte, the method comprising:
i) providing at least one biopolymer protein material in a solvent; and
ii) depositing the at least one biopolymer protein material onto a substrate.

58. The method of claim 57, wherein the film further comprises at least one additive selected from a group consisting of a chemical reagent, a plasticizer, a polarity modifier, an acidity modifier, and combinations thereof.

59. The method of claim 57, wherein the film further comprises at least one reagent.

60. The method of claim 57, wherein the at least one biopolymer protein material comprises a class of alcohol soluble prolamines.

61. The method of claim 60, wherein the class of alcohol soluble prolamines comprises a zein group.

62. The method of claim 57, wherein the at least one quantitative response is selected from a group consisting of a dielectric response, a thickness response, a viscoelastic response, a mass response, and combinations thereof.

63. The method of claim 57, wherein the at least one quantitative response is selected from a group consisting of a chemical response, a physical response, and combinations thereof.

64. The method of claim 57, wherein the sensor film is configured to protect a surface of the at least one sensor.

65. The method of claim 57, wherein providing at least one biopolymer protein material in a solvent comprises dissolving the at least one biopolymer protein material in the solvent.
